(19) United States
(12) Patent Application Publication
(10) Pub. No.: US 2005/0184594 A1
(43) Pub. Date: Aug. 25, 2005

(54) Electric storage augmentation of fuel cell response to AC system transients

(76) Inventor: Steven J. Fredette, South Windsor, CT (US)

Correspondence Address: M.P. Williams, 210 Main Street, Manchester, CT, 06040, US

(21) Appl. No.: 10/783,213

(22) Filed: Feb. 20, 2004

(51) Int. Cl. H02J 1/00

(52) U.S. Cl. 307/78

(57) ABSTRACT

A fuel cell power plant (9) provides DC power to an inverter (12) which provides power to three-phase power lines (16) which are connectable to a power grid (18) by switches (17), and which are connected to a critical customer load (30). An energy storage device (40) provides DC power to a bidirectional DC/AC converter (36) which is connectable through switches (34) to said three-phase power lines or to said power grid. A diode (45) may passively provide fuel cell power plant energy directly to the energy storage device so as to charge it, or bypass the primary DC/AC inverter in the event that it fails. Lapses in power caused by the inverter shutting down due to perturbations on the grid are avoided by power supplied by the converter using energy from the energy storage device.

### TECHNICAL FIELD

This invention relates to a fuel cell power plant having batteries or a bank of supercapacitors connected between the fuel cell power plant power conditioner (DC/AC inverter) and the load by a regenerative (bidirectional) DC/AC converter.

### BACKGROUND ART

When a fuel cell power plant is operating normally and there is a sudden change in the load, the capability of the fuel cell power plant to the change is limited by the time it takes to adjust valves (on the order of seconds) to either provide additional hydrogen, if there is an increase in the load, or to dissipate excess hydrogen, if there is a decrease in the load.

To assist handling transients, it is known to provide DC energy storage devices connected between the fuel cell power plant and the power conditioner associated therewith. One such is disclosed in U.S. Pat. No. 6,572,993, which always readjusts the energy storage device to 80% of its capacity. Another such system is disclosed in copending patent application Ser. No. 10/717,089 filed Nov. 19, 2003, which can passively follow whatever voltage the fuel cell power plant attains, or which may have an active DC/DC converter to permit the energy storage device to function at voltages which are either a fraction of or a multiple of the voltages of the fuel cell power plant.

The aforesaid devices, however, cannot provide power to a critical customer load, or to the auxiliary equipment of the fuel cell power plant itself whenever the power conditioner has stopped switching due to perturbations on the grid or on the critical customer load.

### DISCLOSURE OF INVENTION

Objects of the invention include an energy storage system to augment a fuel cell power plant: which can supply power to a critical customer load and/or the auxiliary power equipment of the fuel cell power plant itself even when the primary power conditioning circuitry associated with the fuel cell power plant has stopped switching due to perturbations on its output, such as on a power grid; which will prevent lapses in power supplied to a critical customer load by the power grid; which will prevent lapses in power supplied to a critical customer load by the fuel cell power plant; which can be recharged by the power grid; which is more versatile and provides a more complete augmentation function than apparatus known to the art.

According to the present invention, an energy storage system is connectable either directly to critical customer load and/or fuel cell power plant auxiliary equipment, or to a power grid, with which the fuel cell power plant is connectable.

According to the invention, a DC storage device, such as a bank of batteries or supercapacitors, is connected through a regenerative (bidirectional) DC/AC converter, which in turn is switchable to be in parallel with the output lines of the fuel cell power plant power converter or to be connected to the power grid.

A principal feature of the invention is that the energy storage system of the invention can actually provide power to a critical customer load, even though the power conditioning system of the fuel cell power plant has stopped switching due to perturbations on its output line. Thus, the present invention provides power where prior art energy storage systems associated with fuel cell power plants cannot, in the event that the power conditioning system shuts down or stops switching.

Other objects, features and advantages of the present invention will become more apparent in the light of the following detailed description of exemplary embodiments thereof, as illustrated in the accompanying drawing.

### BRIEF DESCRIPTION OF THE DRAWINGS

FIG. 1 is a simplified block diagram of an electric storage augmentation system according to the present invention.

FIG. 2 is a fragmentary, simplified schematic diagram of a DC energy storage device comprising batteries.

FIG. 3 is a fragmentary, simplified schematic diagram of a DC energy storage device comprising a bank of supercapacitors.

FIG. 4 is a simplified block diagram of a system according to the present invention, having a diode that will automatically provide power to the DC storage device directly from the fuel cell whenever the fuel cell voltage is higher than that of the storage device.

### MODE(S) FOR CARRYING OUT THE INVENTION

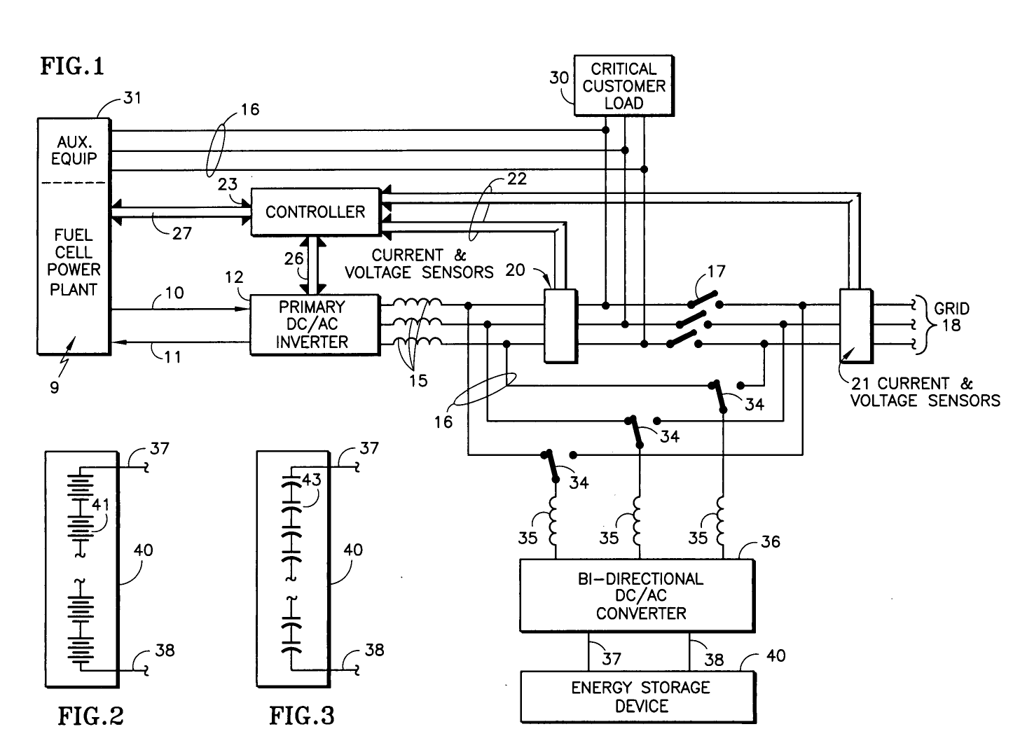

Referring to FIG. 1, a fuel cell power plant 9 is connected by a positive power line 10 and a return line 11 to a power conditioning system which comprises a primary DC/AC inverter 12. The inverter 12 is connected through inductors 15 to three-phase power lines 16 and through a plurality of switches 17 to a power grid 18, which typically is 480 volts, three-phase, 60 Hz power. The switches 17 may be either electromechanical or solid state devices.

A plurality of current and voltage sensors 20, 21 determine the current and voltage of each of the three-phase lines 16 as well as the lines of the power grid 18, and provides signals indicative thereof over a trunk of lines 22 to a controller 23. In this embodiment, the controller 23 is shown interconnected with trunks of lines 26, 27 to the primary DC/AC inverter 12 and to the fuel cell power plant 9.

However, separate controllers may be used if desired. The three-phase power lines 16 are connected to a critical customer load 30 and to the auxiliary equipment 31 of the fuel cell power plant 9. In a typical case, the switches 17 may be closed so that power is supplied from the power grid 18 to the critical customer load 30. In some cases, the source of power may be shared between the fuel cell power plant and the grid.

When the grid is connected through the switches 17 to the inverter 12, in response to conditions indicated by the current and voltage sensors 20, 21, such as a reduction of several volts for more than a few milliseconds, or an abrupt phase change, the controller 23 will immediately stop switching the inverter 12, in a microsecond time frame. It will then disconnect the power grid 18 by opening the switches 17. Thereafter, the controller will monitor both sides of the switches 17 to determine that the grid is normal again, and will then adjust the phase and voltage magnitude in the inverter to that of the grid prior to reconnecting the inverter to the grid through the switches 17. The inductors 15 absorb differences between the grid and the inverter when they are first interconnected.

In the situation described, with the inverter stopped switching and the grid disconnected, the critical customer load 30 will have a lapse of power. According to the invention, power at such a time will be supplied through switches 34 and inductors 35 from a bi-directional DC/AC converter 36 that is connected by lines 37, 38 to an energy storage device 40, which may comprise batteries or a bank of supercapacitors as described hereinafter. The converter 36 may be autonomous, looking at the condition of the lines 16 and when that voltage is sufficiently reduced, the converter 36 will supply power to the line 16. Thus, there is no lapse in power to the critical customer load, nor to the auxiliary equipment 31 of the fuel cell power plant 9.

If desired, in different embodiments, the converter 36 and the inverter 12 may be interconnected, sharing information, either through the controller 23 or through an independent controller separate from the power plant controller. Operation of the converter 36 could be optimized with a controller shared in common with the inverter 12. For instance, at the moment that the inverter is commanded to shut down, the converter could likewise be commanded to supply AC power to the line 16.

The switches 34 may be moved to a position opposite to that shown in FIG. 1, thereby connecting the converter 36 directly to the power grid 18. This would provide the possibility of charging the energy storage device 40 from the power grid 18, when conditions of the power grid are suitable. In such a case, power would not be extracted from the fuel cell power plant 9 in order to recharge the energy storage device 40.

FIG. 2 illustrates an energy storage device 40 which comprises a plurality of batteries 41. FIG. 3 illustrates an energy storage device 40 which comprises a bank of supercapacitors 43.

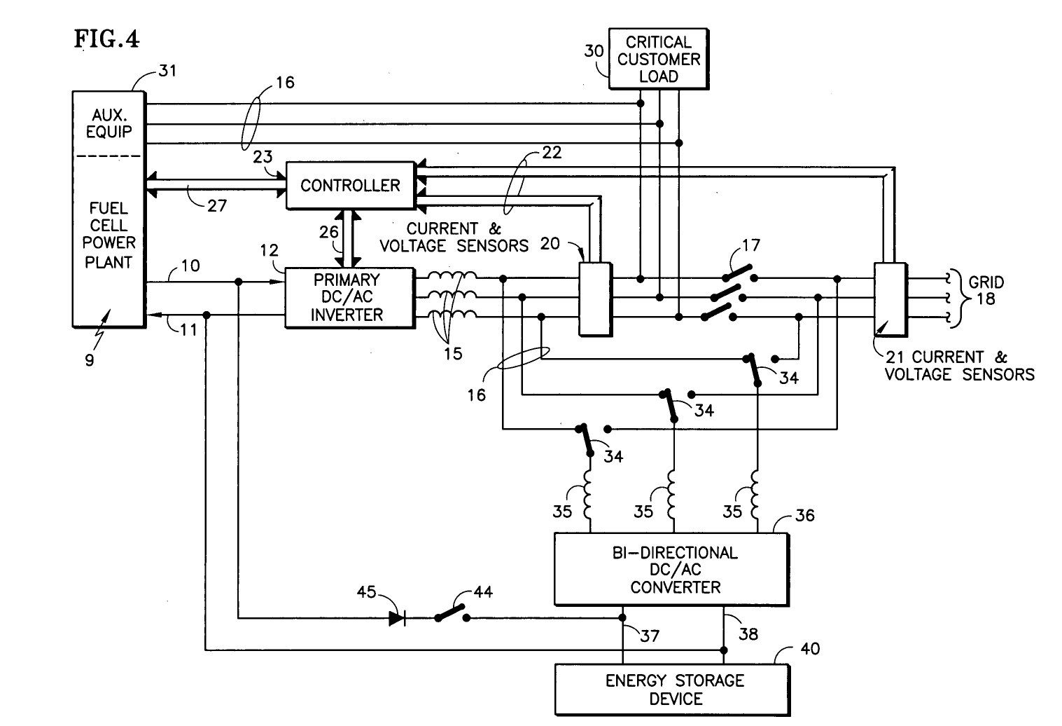

Referring to FIG. 4, the fuel cell power plant 9 may optionally be connected by a diode 45 through a switch 44 directly to the energy storage device 40. As is known, the “performance” of a fuel cell stack is a voltage versus current density relationship which is monotonic downward, the voltage being lower for any incremental increase in current density. Thus, at very low power output, the voltage of the fuel cell power plant approaches maximum voltage, and under such circumstances may exceed the voltage of the energy storage device 40. In such a case (if used and if connected through the switch 44) current will flow through the diode 45 to charge the energy storage device 40.

This configuration can also be used to route power to the critical customer load, auxiliary equipment, or utility grid in the case that the primary DC/AC inverter fails.

All of the aforementioned patents and patent applications are incorporated herein by reference.

Thus, although the invention has been shown and described with respect to exemplary embodiments thereof, it should be understood by those skilled in the art that the foregoing and various other changes, omissions and additions may be made therein and thereto, without departing from the spirit and scope of the invention.

1. Apparatus comprising:
a fuel cell power plant;
a primary DC/AC inverter receiving DC power from said fuel cell power plant and providing three-phase AC power to three-phase power lines;
an energy storage device; and
a bidirectional DC/AC converter connectable from said energy storage device to said three-phase power lines, whereby to augment the response of said fuel cell power plant and said inverter to transients on said lines.

2. Apparatus according to claim 1 wherein said lines are connected to either or both of (a) auxiliary equipment of said fuel cell power plant or (b) a critical customer load, whereby lapses of power to said critical customer load are averted by power supplied by said converter.

3. Apparatus according to claim 1 wherein:
said three-phase power lines are connectable by switches to a three-phase power grid; and
said converter is connected to said three-phase power lines by switches, said converter alternatively connectable by said switches to said power grid.

4. Apparatus according to claim 3 further comprising a diode connected between said fuel cell power plant and said energy storage device to passively provide energy to said energy storage device from said fuel cell power plant whenever there is a sufficiently-low load on said fuel cell power plant so that the voltage output thereof exceeds that of said energy storage device.

5. Apparatus according to claim 4 further comprising:
a switch to interrupt the connection between said fuel cell power plant and said energy storage device through said diode.

6. Apparatus according to claim 4 wherein:
said three-phase power lines are connectable by switches to a three-phase power grid; and
said converter is connected to said three-phase power lines by switches, said converter alternatively connectable by said switches to said power grid, whereby power can be provided by said fuel cell power plant through said diode to said power grid and/or said auxiliary equipment and said critical customer load.
